(19) United States
(12) Patent Application Publication
(10) Pub. No.: US 2024/0177876 A1
(43) Pub. Date: May 30, 2024

(54) FUEL ASSEMBLIES IN FAST REACTOR AND FAST REACTOR CORE

(71) Applicant: Hitachi-GE Nuclear Energy, Ltd., Ibaraki (JP)

(72) Inventors: Kouji FUJIMURA, Tokyo (JP); Junichi MIWA, Tokyo (JP)

(21) Appl. No.: 18/513,776

(22) Filed: Nov. 20, 2023

(30) Foreign Application Priority Data
Nov. 25, 2022 (JP) 2022-188164

(51) Int. Cl. G21C 3/326; G21C 1/02; G21C 3/20

(52) U.S. Cl. CPC G21C 3/3265; G21C 1/022; G21C 3/20

(57) ABSTRACT

Disclosed are fuel assemblies that are loaded in the core of a fast reactor including first fuel assemblies and second fuel assemblies being different from the first fuel assemblies. The reactor core has an axially heterogeneous core structure in which an internal blanket region containing depleted uranium fuel is placed around an axially middle section of the core. The first fuel assemblies are loaded in an outer core fuel region extending toward the periphery of the reactor core in a radial direction and the second fuel assemblies are loaded in an inner core fuel region extending around the center of the reactor core in a radial direction. Thickness of an internal blanket in each of the first fuel assemblies in an axial direction of the reactor core is thicker than thickness of an internal blanket in each of the second fuel assemblies in the axial direction of the reactor core.

### CLAIM OF PRIORITY

The present application claims priority from Japanese Patent application serial no. 2022-188164, filed on Nov. 25, 2022, the content of which is hereby incorporated by reference into this application.

### BACKGROUND OF THE INVENTION

The present invention relates to fuel assemblies in a fast reactor and the fast reactor core into which those assemblies are loaded. Particularly, the invention pertains to an effectual technology for application to a fast reactor with a heat storage system using molten salts being built adjacent thereto for co-working.

For a fast breeder reactor, generally, a reactor core is placed inside its reactor vessel and the interior of the reactor vessel is filled with liquid sodium as a coolant.

Fuel assemblies that are loaded into the reactor core each include a plurality of fuel rods into which depleted uranium (U-238) is encapsulated as plutonium (Pu)-enriched fuel. Each fuel assembly also includes a wrapper tube surrounding a bundle of the fuel rods, an entrance nozzle supporting a neutron shield located in the bottom end of the fuel rods and under the fuel rods, and a coolant outlet located over the fuel rods.

The fast breeder reactor core includes an inner core region, a core fuel region having an outer core region surrounding the inner core region, a blanket fuel region surrounding the core fuel region, and a shield region surrounding the blanket fuel region. In the case of a standard homogeneous reactor core, the Pu enrichment of fuel assemblies loaded in the outer core region is higher than the Pu enrichment of fuel assemblies loaded in the inner core region. In consequence, the distribution of power density of the reactor core in a radial direction is flattened.

Nuclear fuel materials that are contained in respective fuel rods of fuel assemblies are available with the following types: metallic fuel, nitride fuel, and oxide fuel. Among them, oxide fuel is most frequently used.

An axially middle section inside a fuel rod at a height of about 80 to 100 cm is full of pellets of a mixed oxide fuel in which a Pu oxide and a depleted uranium oxide are mixed, namely, MOX fuel. Also, inside the fuel rod, there are regions of radial blankets filled with a plurality of uranium dioxide pellets made of depleted uranium, placed in upper and lower portions of the MOX fuel fill region. Inner core fuel assemblies loaded in the inner core region and outer core fuel assemblies loaded in the outer core region each include a plurality of fuel rods, each rod being filled with a plurality of MOX fuel pellets, as above. The Pu enrichment of the outer core fuel assemblies is higher than that of the inner core fuel assemblies.

In the blanket fuel region surrounding the core fuel region, blanket fuel assemblies are loaded, each assembly including a plurality of fuel rods filled with a plurality of uranium dioxide pellets made of depleted uranium. Among neutrons generated by nuclear fission reaction occurring inside the fuel assemblies loaded in the core fuel region, neutrons leaked out of the core fuel region are absorbed by depleted uranium (U-238) inside the respective fuel rods of the blanket fuel assemblies loaded in the blanket fuel region. In consequence, fissile nuclides, Pu-239 are newly generated inside the respective fuel rods of the blanket fuel assemblies.

Besides, control rods are used at the startup and shutdown of a fast breeder reactor and when an adjustment is made to reactor power. A control rod includes a plurality of neutron absorption rods in which boron carbide (B₄C) pellets are encapsulated into a cladding tube made of stainless steel and has a structure in which these neutron absorption rods are enclosed by a wrapper tube having a regular hexagonal cross section, as with the inner and outer core fuel assemblies. Control rods are organized into two independent systems for a primary shutdown system and a backup shutdown system. Only either of the systems for a primary shutdown system and a backup shutdown system enables emergency shutdown of a fast breeder reactor.

In a technical field to which the present invention pertains, there exists a technology as disclosed in, e.g., Japanese Unexamined Patent Application Publication No. 2005-83966. Disclosed in this publication is “a fast reactor that uses metallic fuel and is partitioned into a plurality of core regions in order to flatten its power density distribution”.

### SUMMARY OF THE INVENTION

By the way, towards carbon neutral achievement by 2050, nuclear power generation is required to be adaptable to variation in loads due to mass introduction of renewable energy. In US, information about a plant that responds to variation in loads by building a heat storage system using molten salts, recognized to perform well in solar power generation, adjacent to a small sodium-cooled, metallic fuel fast reactor for co-working is released.

In most instances of metallic fuel fast reactors, the primary system coolant outlet temperature of the reactor is designed to be lower by about 50 degrees in Celsius than oxide fuel fast reactors from a perspective of ensuring integrity of metallic fuel. In the case of a small sodium-cooled, metallic fuel fast reactor, the above temperature is assumed to be approx. 500° C. Meanwhile, if sulfate-based molten salts are used in a heat storage system recognized to perform well in solar power generation, it is desirable that the reactor coolant outlet temperature ranges from about 540° C. to 550 ° C. in consideration of conditions of the molten salt melting point and hot-side tank temperature of the heat storage system.

In order to improve the coolant outlet temperature in a sodium-cooled, metallic fuel fast reactor, it is required to flatten power density distribution, cut down a useless flow quantity, and reduce the coolant flow rate.

Japanese Unexamined Patent Publication No. 2005-83966 mentioned above suggests a method in which the Zr content rate of a U-Pu-Zr metallic fuel in the inner core region is made higher than that rate in the outer core region where more neutron leakage occurs for flattening power density distribution.

However, a problem found in the method according to Japanese Unexamined Patent Publication No. 2005-83966 is that a decrease in the loading amount of heavy metal (U or Pu) in the inner core region results in degradation of reactor core performance such as a breeding ratio and burnup reactivity.

Then, an object of the present invention resides in providing fuel assemblies in a fast reactor and the fast reactor core with those assemblies being loaded therein, enabling it to flatten power density distribution and increase the coolant outlet temperature, while preventing reactor core performance from degrading.

To solve the above-noted problem, the present invention resides in fuel assemblies that are loaded in the core of a fast reactor including first fuel assemblies and second fuel assemblies being different from the first fuel assemblies. The reactor core has an axially heterogeneous core structure in which an internal blanket region containing depleted uranium fuel is placed around an axially middle section of the core. The first fuel assemblies are loaded in an outer core fuel region extending toward the periphery of the reactor core in a radial direction and the second fuel assemblies are loaded in an inner core fuel region extending around the center of the reactor core in a radial direction. Thickness of an internal blanket in each of the first fuel assemblies in an axial direction of the reactor core is thicker than thickness of an internal blanket in each of the second fuel assemblies in the axial direction of the reactor core.

According to the prevent invention, it is possible to provide fuel assemblies in a fast reactor and the fast reactor core with those assemblies being loaded therein, enabling it to flatten power density distribution and increase the coolant outlet temperature, while preventing reactor core performance from degrading.

It is thus possible to realize a sodium-cooled, metallic fuel fast reactor that is highly compatible with a heat storage system using molten salts.

Problems, configurations, and advantageous effects other than noted above will be apparent from the following description of embodiments of the present invention.

### BRIEF DESCRIPTION OF THE DRAWINGS

FIG.. 1A is a couple of horizontal cross sections of core fuel assemblies in a fast reactor in relevance to a first embodiment of the present invention.

FIG. 1B is a horizontal cross section of a half of the fast reactor core with the core fuel assemblies in FIG. 1A being loaded therein.

FIG. 2 is a couple of longitudinal cross sections of the core fuel assemblies in FIG. 1A.

FIG. 3 is a longitudinal cross section of the fast reactor core in relevance to the first embodiment of the present invention.

FIG. 4 is a graph representing how the infinite multiplication factor of neutrons depends on burn-up in fuel assemblies in a metallic fuel fast reactor.

FIG. 5 is a graph representing how change in maximum reactivity depends on Pu enrichment during a period of burnup in inner core fuel assemblies.

FIG. 6 is a longitudinal cross section of a half of a fast reactor core in relevance to a second embodiment.

FIG. 7 is a couple of longitudinal cross sections of core fuel assemblies which are loaded in the reactor core in FIG. 6.

### DETAILED DESCRIPTION OF THE PREFERRED EMBODIMENTS

Hereinafter, embodiments of the present invention are described with the aid of drawings. Across the drawings, an identical reference sign is assigned to components identical to each other and detailed descriptions of overlapping parts are omitted.

### FIRST EMBODIMENT

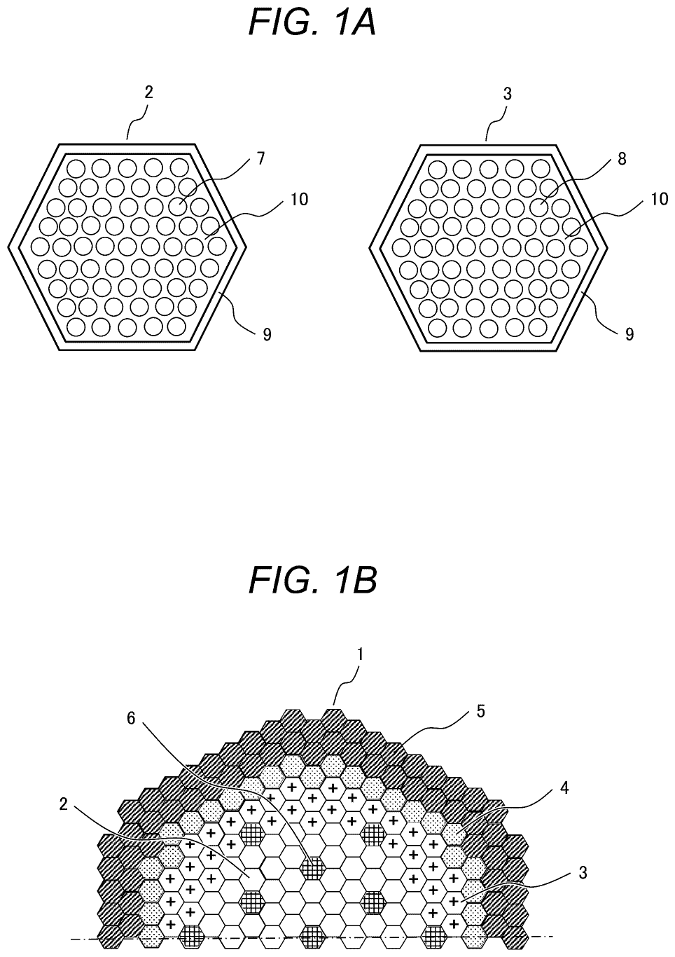

Referring to FIGS. 1A to 5, descriptions are provided about fuel assemblies in a fast reactor and the fast reactor core in relevance to a first embodiment of the present invention.

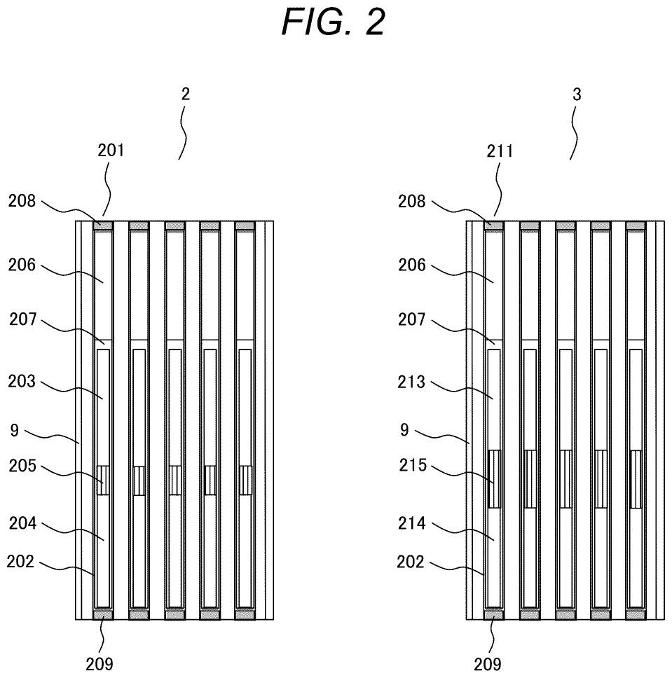

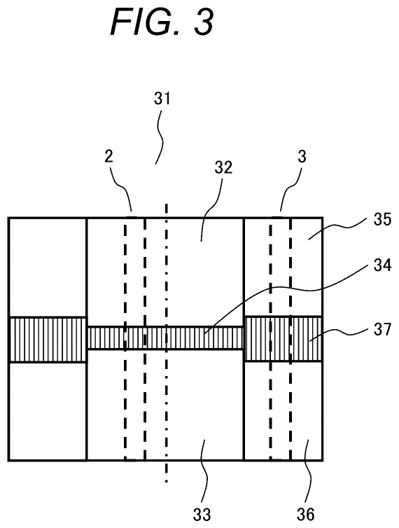

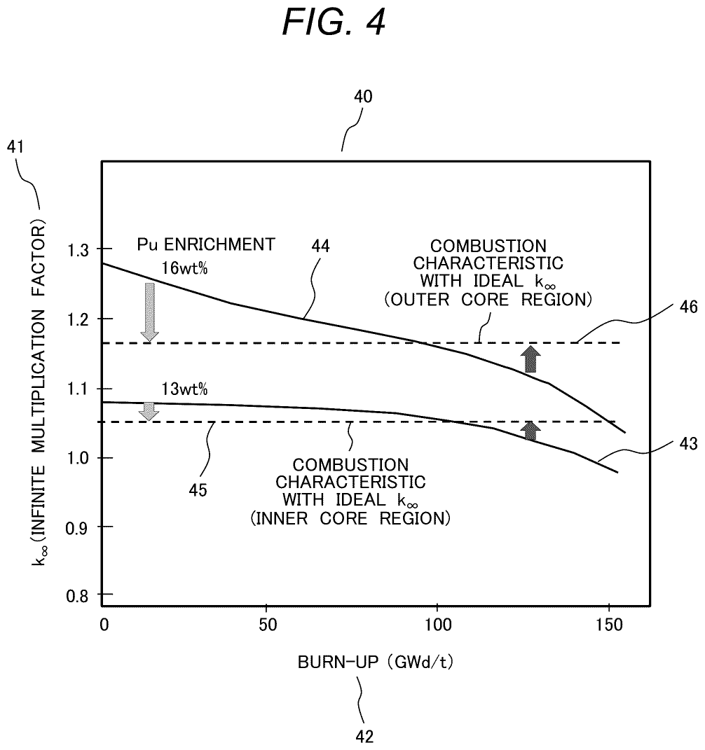

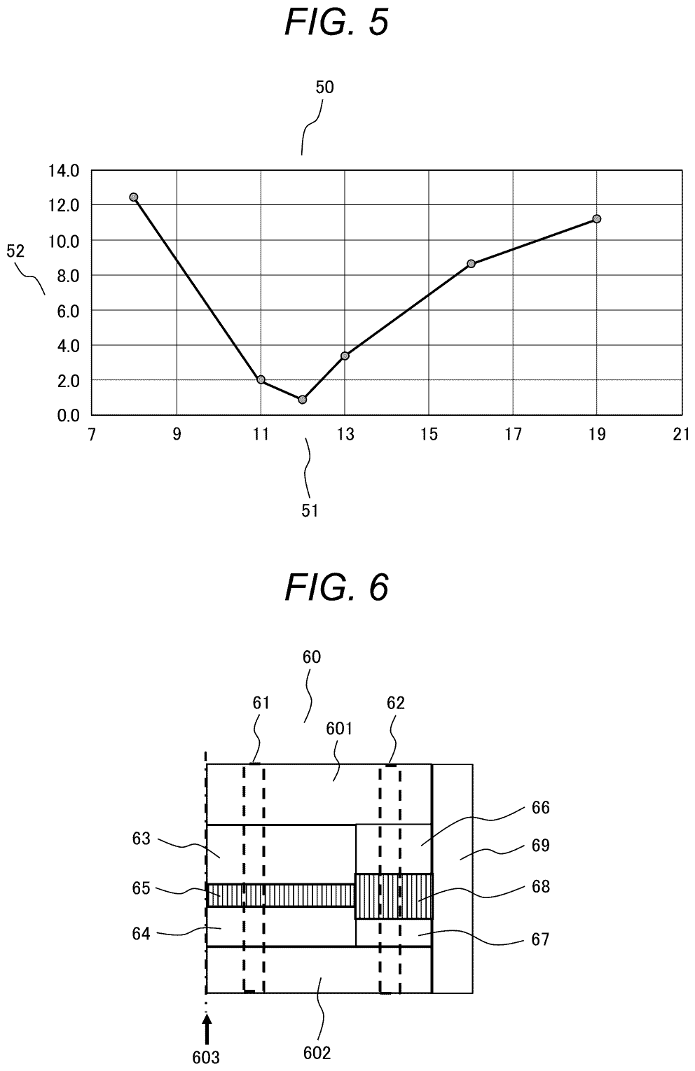

FIG. 1A is a couple of horizontal cross sections of core fuel assemblies in the fast reactor of the present embodiment. A left diagram in FIG. 1A depicts an inner core fuel assembly 2 and a right diagram in FIG. 1A depicts an outer core fuel assembly 3. FIG. 1B is a horizontal cross section of a half of the fast reactor core with the core fuel assemblies 2, 3 in FIG. 1A being loaded therein. FIG. 2 is a couple of longitudinal cross sections of the fuel assemblies 2, 3 in FIG. 1A. FIG. 3 is a longitudinal cross section of the fast reactor core of the present embodiment. FIG. 4 is a graph representing how the infinite multiplication factor of neutrons depends on burn-up in fuel assemblies in a metallic fuel fast reactor. FIG. 5 is a graph representing how change in maximum reactivity depends on Pu enrichment during a period of burnup in the inner core fuel assembly 2.

The inner core fuel assembly 2 depicted in the left diagram in FIG. 1A is that in which fuel rods 7 containing a U-Pu-Zr alloy are densely arranged in triangular pitches inside a hexagonal wrapper tube 9 made of stainless steel. Gaps between each of the fuel rods 7 inside the wrapper tube 9 are filled with coolant sodium 10 which is a coolant flowing from the bottom of the inner core fuel assembly 2 toward an upstream direction.

It is assumed here that the inner core fuel assembly 2 has a pitch of 161.4 mm, a fuel rod cladding tube (not depicted) has a diameter of 8.7 mm, and each of the U-Pu-Zr alloy fuel rods 7 enclosed by fuel rod cladding tubes has a diameter of 6.7 mm. Besides, e.g., a total of 217 fuel rods 7 are put in the inner core fuel assembly 2, though simplified in the diagram. Besides, a volume ratio of metallic fuel occupied in the inner core fuel assembly 2 is 33.6%, including gaps between the inside surface of each fuel rod cladding tube and each fuel rod 7.

On the other hand, for the outer core fuel assembly 3 depicted in the right diagram in FIG. 1A, its specifications in the horizontal cross section are the same as those of the inner core fuel assembly 2 noted above. However, these assemblies differ from each other in respect of their fuel configurations in a height direction, as will be described later.

As depicted in FIG. 1B, the horizontal cross section of a half of the fast reactor core, the fast reactor core 1 is made up of an inner core fuel region where inner core fuel assemblies 2 are loaded, an outer core fuel region where outer core fuel assemblies 3 are loaded, which surrounds the inner core fuel region, a radial blanket fuel region where radial blanket fuel assemblies 4 containing a U-Zr alloy as blanket fuel are loaded, which surrounds the outer core fuel region, a shield region where shield assemblies 5 are loaded, which further surrounds the radial blanket fuel region, and control rod assemblies 6 which are put in place in the core fuel regions.

Using FIG. 2, descriptions are provided to explain the configurations of the inner core fuel assembly 2 and the outer core fuel assembly 3 in a height direction.

A fuel rod 201 loaded in the inner core fuel assembly 2 includes a cylindrically formed upper core fuel 203 containing a U-Pu-Zr alloy and a cylindrically formed lower core fuel 204 containing a U-Pu-Zr alloy. Between the upper core fuel 203 and the lower core fuel 204, an internal blanket fuel 205 containing a U-Zr alloy is put, immersed in a liquid of bonded sodium 207 inside a cylindrically formed fuel cladding tube 202 made of stainless steel. Over these fuels, a gas plenum 206 is formed to hold gaseous fission products (FPs). The fuel cladding tube 202 is sealed by welding an upper end plug 208 and a lower end plug 209 thereto at its top and bottom ends.

Both the upper core fuel 203 containing a U-Pu-Zr alloy and the lower core fuel 204 containing a U-Pu-Zr alloy have a longitudinal length of 450 mm. The internal blanket fuel 205 containing a U-Zr alloy has a longitudinal length of 100 mm. The sum of these lengths is 1000 mm.

The outer core fuel assembly 3 also has the same structure as the inner core fuel assembly 2. A difference between these assemblies lies in that both an upper core fuel 213 containing a U-Pu-Zr alloy and a lower core fuel 214 containing a U-Pu-Zr alloy have a longitudinal length of 400 mm and an internal blanket fuel 215 containing a U-Zr alloy has a length of 200 mm. A total length is 1000 mm, as is the case for the inner core fuel assembly 2.

Using FIG. 3, descriptions are provided about the fast reactor core 31 in which the core fuel assemblies 2, 3 of the present embodiment are loaded.

The inner core fuel region extending around the center of the reactor core 31 is made up of an upper core fuel region 32, a lower core fuel region 33, and an internal blanket region 34. The outer core fuel region extending toward the periphery of the reactor core 31 is made up of an upper core fuel region 35, a lower core fuel region 36, and an internal blanket region 37.

As depicted in FIG. 3, the fast reactor core 31 of the present embodiment differs from an axially heterogeneous core of prior art in a point that thickness of the internal blanket region 37 in the outer core fuel region is larger (thicker) than thickness of the internal blanket region 34 in the inner core fuel region in an axial direction of the reactor core 31.

Using FIG. 4, descriptions are provided to explain a principle in which temporal and spatial variation in power density distribution can be restrained by configuring the core as described hereinbefore.

An infinite multiplication factor (k∞) of neutrons in fuel assemblies is a physical quantity that corresponds to power of the fuel assemblies loaded in the reactor core. Hereinafter, a curve indicating how the infinite multiplication factor of neutrons depends on burn-up is simply referred to as a burnup characteristic.

A reference sign 43 denotes the burnup characteristic of inner core fuel assemblies when a conventional homogeneous core configuration of prior art having double regions of Pu enrichment is applied. Assuming that the Pu enrichment of the upper and lower core fuels 203, 204 containing a U-Pu-Zr alloy in the inner core fuel assemblies 2 loaded in the reactor core 31 of the present embodiment having an axially heterogeneous core configuration is equal to the Pu enrichment in the fuel assemblies having the burnup characteristic denoted by the reference sign 43, it is possible to decrease the infinite multiplication factor of neutrons by a neutron capture reaction of U-238 in depleted U of the internal blanket fuel 205 containing a U-Zr alloy in the beginning of burnup. As burnup continues, Pu-239 accumulates which is generated during the neutron capture reaction of U-238 in the internal blanket fuel 205 and this enables it to increase the infinite multiplication factor of neutrons in a terminal stage of burnup. Thus, an ideal burnup characteristic denoted by a reference sign 45 is obtained, indicating that variation in the power of the fuel assemblies during burnup is eliminated.

A reference sign 44 denotes the burnup characteristic of outer core fuel assemblies when the conventional homogeneous core configuration of prior art is applied. In the outer core region nearer to the periphery of the reactor core 31, the power of the fuel assemblies decreases because of leakage of neutrons. The Pu enrichment in this region is made higher than that of the inner core fuel assemblies 2 to flatten power density distribution in a radial direction. This results in a decrease of an internal conversion ratio and, consequently, yields the burnup characteristic, as denoted by the reference sign 44, in which the infinite multiplication factor of neutrons decreases at a greater rate than the curve denoted by the reference sign 43.

In the reactor core 31 of the present embodiment, the internal blanket region 37 containing a U-Zr alloy in the outer core fuel assemblies 3 is in an elevated position higher than the internal blanket region 34 containing a U-Zr alloy in the inner core fuel assemblies 2. This enhances the effect of the neutron capture reaction with U-238 in the beginning of burnup and also enhances the effect of increasing the infinite multiplication factor of neutrons through the accumulation of Pu-239 in a terminal stage of burnup. Thus, in the outer core region, an ideal burnup characteristic denoted by a reference sign 46 is obtained.

We apply the principle described above to the reactor core 31 of the present embodiment. In carrying out multiple recycling in a metallic fuel core, we assumed the use of trans-uranium (TRU) elements having a fuel composition as described below.

Pu238, Pu239, Pu240, Pu241, Pu242, Np237, Am241, Am243, Cm244, and Cm245 are 1.1, 66.0, 25.2, 2.4, 2.4, 0.4, 1.6, 0.5, 0.4, and 0.1 wt %, respectively.

We evaluated the burnup characteristic of the inner core fuel assemblies 2 that use a U-TRU-10% Zr alloy and evaluated change in the maximum reactivity during a period of burnup, using a standard nuclear calculation method for fast reactors in Japan and nuclear data sets for fast reactors based on JENDL-4.0 widely recognized to perform well. A result of our evaluation is presented in FIG. 5.

In FIG. 5, a reference sign 51 denotes an average Pu enrichment across the inner core fuel assemblies 2 and a reference sign 52 denotes change in the maximum reactivity. It can be seen from FIG. 5 that, when the average Pu enrichment is 12 wt % (the Pu enrichment of the upper and lower core fuels 203, 204 is 13 wt %), change in the maximum reactivity 52 becomes minimal and temporal variation in the power of the fuel assemblies is minimized.

Also, for the outer core fuel assemblies 3, we confirmed that, when their average Pu enrichment is 13 wt % (the Pu enrichment of the upper and lower core fuels 213, 214 is 16 wt %), temporal variation in the power of the fuel assemblies can be minimized and spatial output distribution in a radial direction of the reactor core 31 can be flattened.

Therefore, the Pu enrichment of the upper core fuel 203 containing a U-TRU-Zr alloy and the lower core fuel 204 containing a U-TRU-Zr alloy in the inner core fuel assemblies 2 as depicted in FIG. 2 is 13 wt %. The Pu enrichment of the upper core fuel 213 containing a U-TRU-Zr alloy and the lower core fuel 214 containing a U-TRU-Zr alloy in the outer core fuel assemblies 3 is 16 wt %.

As described hereinbefore, the fuel assemblies in the fast reactor and the fast reactor core, as discussed in the present embodiment, make it possible to curtail a useless flow quantity and achieve increasing the coolant outlet temperature of the reactor.

In the present embodiment, under the conditions that the reactor's electric output is 311 MW and thermal output is 840 MW and average discharge fuel burn-up of core fuel is approx. 100 GWd/t, it is possible to flatten power density distribution in a radial direction by loading the core fuel assemblies having the specifications presented in Table 1.

Furthermore, by minimizing temporal variation in power of fuel assembly through burnup cycles, it is possible to curtail a useless flow quantity and increase the coolant output temperature of the reactor core from approx. 500° C. to approx. 550° C. This is confirmed by core calculation.

TABLE 1

| Item | Unit | Specification |
|---|---|---|
| Fuel assembly pitch | mm | 161.4 |
| Distance between outer faces of fuel assembly | mm | 157.1 |
| Wrapper tube thickness | mm | 5.13 |
| Number of fuel rods | — | 217 |
| Fuel rod cladding tube diameter | mm | 8.70 |
| Cladding tube thickness | mm | 0.5 |
| Metallic fuel slug diameter | mm | 6.7 |
| Fuel smear density inside fuel rod cladding tube | % TD | 75 |
| Volume ratio of fuel inside assembly | Vol % | 33.6 |

By the foregoing, improvement can be made of compatibility with a heat storage system using molten salts. Besides, it is possible to increase thermal efficiency by increasing the coolant outlet temperature of the reactor core by approx. 50° C. Also, an advantageous effect of improving economic efficiency can be obtained.

### SECOND EMBODIMENT

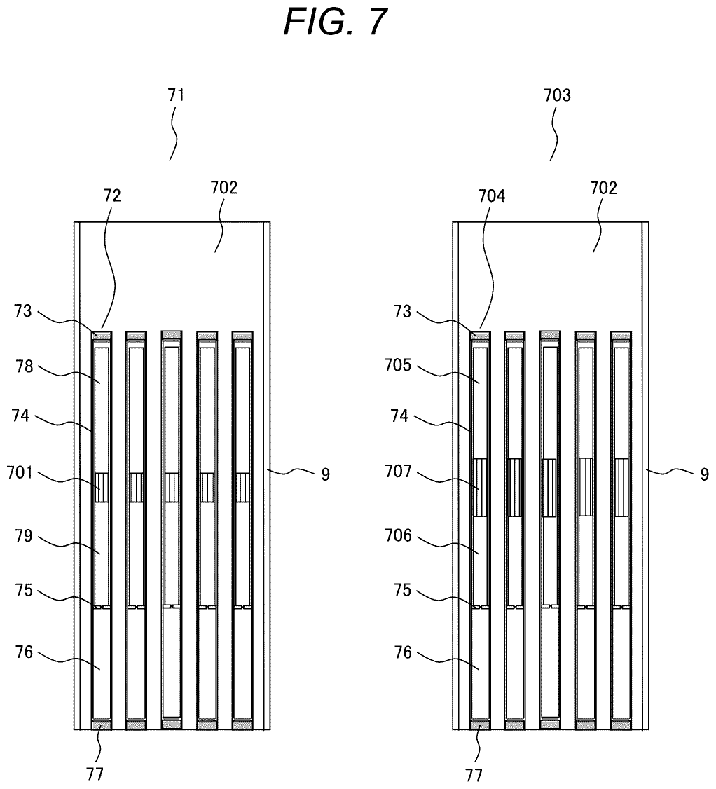

Referring to FIGS. 6 and 7, descriptions are provided about fuel assemblies in a fast reactor and the fast reactor core in relevance to a second embodiment of the present invention.

FIG. 6 is a longitudinal cross section of a half of the fast reactor core of the present embodiment. FIG. 7 is a couple of longitudinal cross sections of an inner core fuel assembly 71 and an outer core fuel assembly 703 which are loaded in the reactor core 60 in FIG. 6.

In the present embodiment, pellets of mixed oxide (MOX) fuel are assumed to be used as core fuel. Using FIG. 7, descriptions are provided on the structures of core fuel assemblies.

In the inner core fuel assembly 71, a fuel rod 72 includes a cylindrically formed upper core fuel 78 as MOX fuel and a cylindrically formed lower core fuel 79 as MOX fuel. Between the upper core fuel 78 and the lower core fuel 79, an internal blanket fuel 701 using a depleted uranium oxide UO₂ is enclosed in a position above a support member 75 inside a cylindrically formed fuel cladding tube 74 made of stainless steel.

Beneath these fuels, a gas plenum 76 is formed to hold gaseous fission products (FPs). The fuel cladding tube 74 is sealed by welding an upper end plug 73 and a lower end plug 77 thereto at its top and bottom ends.

Fuel rods 72 are bundled, densely arranged in triangular pitches, and contained in a hexagonal wrapper tube 9. Over the fuel rod bundle, there is disposed a sodium plenum region 702 containing only flowing sodium.

The outer core fuel assembly 703 also has the same structure as the inner core fuel assembly 71. However, its internal blanket fuel 707 is in an elevated position higher than the internal blanket fuel 701 in the inner core fuel assembly 71 in an axial direction of the reactor core 60, as is the case for the first embodiment.

Additionally, the horizontal cross sections of the inner core fuel assembly 71 and the outer core fuel assembly 703 are the same as the horizontal cross sections of the inner core fuel assembly 2 and the outer core fuel assembly 3 for the first embodiment (FIG. 1A).

Difference from the first embodiment lies in that both the internal blanket fuels 701, 707 are placed with their central cross sections in a height direction being shifted downward by 50 mm and the upper core fuels 78, 705 are longer than the lower core fuels 79, 706.

Besides, the specifications of the reactor core 60 are the same as in the first embodiment (FIG. 3). The specifications of the core fuel assemblies 71, 703 are the same as those presented in Table 1 in the case of a metallic fuel reactor core for the first embodiment. However, difference lies in that the fuel smear density inside the fuel cladding tube 74 increases to 90%TD and the diameter of a MOX fuel pellet is larger.

Using FIG. 6, descriptions are provided about the fast reactor core 60 with the core fuel assemblies 71, 703 of the present embodiment being loaded therein.

A main difference from the longitudinal cross section of the reactor core 31 of the first embodiment depicted in FIG. 3 lies in the following points: the gas plenum region 602 is placed in a bottom part of the reactor core 60; the sodium plenum region 601 is placed in a top part of the reactor core 60; and the internal blanket region 65 in the inner part of the core and the internal blanket region 68 in the outer part of the core are placed with their central cross sections in a height direction being shifted downward from the core fuel region by 50 mm.

Supposing occurrence of Unprotected Loss of Flow (ULOF), dual trouble of an event of flow loss and scram failure in the worst case, as temperature of an upper part of the reactor core rises, density of coolant sodium in the sodium plenum region 601 would decrease and the amount of neutrons that leak upward in the reactor core would increase, resulting in a decrease in reactivity.

In the reactor core 60 of the present embodiment, the internal blanket regions 65, 68 are set shifted downward, as noted previously, and neutron flux at the top part of the core increases compared to when an arrangement of upper and lower core fuels is vertically symmetrical. This increases an effect of negative reactivity in case of the above-mentioned ULOF and makes it possible to avoid boiling of coolant sodium and an advantageous effect of enhancing inherent safety is obtained.

In the embodiments so far described, while the sodium coolant is assumed to be used, the same advantageous effects can be achieved even when a lead coolant or lead-bismuth coolant is used. Also, while metallic fuel and MOX fuel are assumed to be used, the same advantageous effects can be obtained even when nitride fuel is used. Furthermore, the same advantageous effects can be obtained even when any combination of each of the above-mentioned coolants and each of the above-mentioned fuels is applied.

Note that the present invention is not limited to the embodiments described hereinbefore and various modifications are included therein. By way of example, the foregoing embodiments are those described in detail to explain the present invention to make it easy to understand and the invention is not necessarily limited to those including all components described. Besides, a subset of the components of an embodiment may be replaced by components of another embodiment and components of another embodiment may be added to the components of an embodiment. Besides, for a subset of the components of each embodiment, other components may be added to the subset or the subset may be removed or replaced by other components.

### REFERENCE SIGNS LIST

1: fast reactor core (a half of the core)
2, 71: inner core fuel assembly
3, 703: outer core fuel assembly
4: radial blanket fuel assembly
5: shield assembly
6: control rod assembly
7: fuel rod in an inner core fuel assembly
8: fuel rod in an outer core fuel assembly
9: wrapper tube
10: coolant sodium
31: fast reactor core
32: upper core fuel region in the inner core region
33: lower core fuel region in the inner core region
34: internal blanket region in the inner core region
35: upper core fuel region in the outer core region
36: lower core fuel region in the outer core region
37: internal blanket region in the outer core region
40: graph representing a method for obtaining burnup change giving an ideal infinite multiplication factor of neutrons in the fuel assemblies in the inner and outer core regions.
41: infinite neutron multiplication factor
42: burn-up
43: burnup characteristic of inner core fuel assemblies in a homogeneous reactor core
44: burnup characteristic of outer core fuel assemblies in a homogeneous reactor core
45: ideal burnup characteristic of inner core fuel assemblies
46: ideal burnup characteristic of outer core fuel assemblies
50: graph representing how change in maximum reactivity depends on Pu enrichment in inner core fuel assemblies
51: average Pu enrichment across the inner core fuel assemblies
52: change in maximum reactivity
60: reactor core
63: upper core fuel region in the inner core region
64: lower core fuel region in the inner core region
65: internal blanket region in the inner core region
66: upper core fuel region in the outer core region
67: lower core fuel region in the outer core region
68: internal blanket region in the outer core region
69: radial blanket fuel region
72: fuel rod in an inner core fuel assembly
73: upper end plug
74, 202: fuel cladding tube
75: support member
76: gas plenum
77: lower end plug
78: upper core fuel in an inner core fuel assembly
79: lower core fuel in an inner core fuel assembly
201: fuel rod in an inner core fuel assembly
203: upper core fuel in an inner core fuel assembly
204: lower core fuel in an inner core fuel assembly
205: internal blanket fuel in an inner core fuel assembly
206: gas plenum
207: bonded sodium
208: upper end plug
209: lower end plug
211: fuel rod in an outer core fuel assembly
213: upper core fuel in an outer core fuel assembly
214: lower core fuel in an outer core fuel assembly
215: internal blanket fuel in an outer core fuel assembly
601: sodium plenum region
602: gas plenum region
701: internal blanket fuel in an inner core fuel assembly
702: sodium plenum region
704: fuel rod in an outer core fuel assembly
705: upper core fuel in an outer core fuel assembly
706: lower core fuel in an outer core fuel assembly
707: internal blanket fuel in an outer core fuel assembly

What is claimed is:

1. Fuel assemblies that are loaded in the core of a fast reactor, comprising:
first fuel assemblies; and
second fuel assemblies being different from the first fuel assemblies,
the reactor core having an axially heterogeneous core structure in which an internal blanket region containing depleted uranium fuel is placed around an axially middle section of the core,
the first fuel assemblies being loaded in an outer core fuel region extending toward the periphery of the reactor core in a radial direction, and
the second fuel assemblies being loaded in an inner core fuel region extending around the center of the reactor core in a radial direction,
wherein thickness of an internal blanket in each of the first fuel assemblies in an axial direction of the reactor core is thicker than thickness of an internal blanket in each of the second fuel assemblies in the axial direction of the reactor core.

2. The fuel assemblies in the fast reactor according to claim 1,
wherein Pu enrichment in core fuel regions in each of the first fuel assemblies is higher than Pu enrichment in core fuel regions in the second fuel assemblies.

3. The fuel assemblies in the fast reactor according to claim 1,
the fast rector is a sodium cooled fast reactor.

4. The fuel assemblies in the fast reactor according to claim 1,
wherein the first fuel assemblies and the second fuel assemblies each have an internal arrangement in which a metallic fuel of a U-TRU-Zr alloy is put in place as core fuel and a metallic fuel of a U-Zr alloy is put in place as an internal blanket.

5. The fuel assemblies in the fast reactor according to claim 1,
wherein Pu enrichment of core fuel in each of the second fuel assemblies is 13 wt %, and
Pu enrichment of core fuel in each of the first fuel assemblies is 16 wt %.

6. The fuel assemblies in the fast reactor according to claim 1,
wherein:
a sodium plenum region is disposed in a top part of the reactor core;
MOX fuel pellets are placed in core fuel regions in each of the first fuel assemblies and the second fuel assemblies;
depleted uranium oxide pellets are placed in internal blankets in each of the first fuel assemblies and the second fuel assemblies; and
for the internal blanket region, its central cross section in a height direction is positioned in a height direction, shifted downward lower than the central cross section in a height direction of a total longitudinal length of upper and lower core fuel regions and the internal blanket region.

7. A fast reactor core with the fuel assemblies in the fast reactor according to claim 1 being loaded therein.

8. A fast reactor core with the fuel assemblies in the fast reactor according to claim 2 being loaded therein.
